(19) United States
(12) Patent Application Publication
(10) Pub. No.: US 2010/0201699 A1
(43) Pub. Date: Aug. 12, 2010

(54) DISPLAY APPARATUS AND DATA TRANSMITTING SYSTEM

(75) Inventors: Takuya Nagai, Nagoya-shi (JP); Yoshihisa Kusumoto, Nagoya-shi (JP); Yu Matsubara, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 12/702,911

(22) Filed: Feb. 9, 2010

(30) Foreign Application Priority Data
Feb. 12, 2009 (JP) 2009-029231

(51) Int. Cl. G06F 13/38

(52) U.S. Cl. 345/537

(57) ABSTRACT

A display apparatus, including: a nonvolatile display device that retains display of information even after the power is cut, a data receiving device that receives data to be displayed on the nonvolatile display device, a volatile storage device that stores the data received by the data receiving device, a nonvolatile storage device that retains the storage of the data even after the power is cut, a display control device that causes the nonvolatile display device to display the data stored in the volatile storage device, a storage determining device that determines whether to store the data stored in the volatile storage device into the nonvolatile storage device, and a storage control device that causes the nonvolatile storage device to store the data stored in the volatile storage device when the storage determining device determines to store the data into the nonvolatile storage device.

### CROSS-REFERENCE TO RELATED APPLICATION

The present application claims priority from Japanese Patent Application No. 2009-029231, which was filed on Feb. 12, 2009, the disclosure of which is herein incorporated by reference in its entirety.

### BACKGROUND

The present disclosure relates to a display apparatus and a data transmitting system. More specifically, the present disclosure relates to a display apparatus and a data transmitting system which are capable of selecting whether received image data is saved.

Conventionally, an image display apparatus that receives image data from a document management server and displays it on a nonvolatile display portion is known. In such an image display apparatus, the document management server, upon receipt of a request to transmit image data from the image display apparatus via a network, transmits the image data to the image display apparatus according to the request. The image display apparatus displays the received image data on the display portion, and then deletes the image data from a buffer memory. As a result, leakage of the image data as classified information can be prevented.

### SUMMARY

In the above image display apparatus, however, since received image data is deleted from the buffer memory after being displayed, a user cannot select whether to save necessary image data.

To solve the above problem, this disclosure has been developed. It is an object of the disclosure to provide a display apparatus and a data transmitting system which are capable of determining and controlling whether received image data is saved in a nonvolatile storage device in the image display apparatus.

To solve the problem described above, a display apparatus in a first aspect of this disclosure includes a nonvolatile display device that retains display of information even after the power is cut, a data receiving device that receives data to be displayed on the nonvolatile display device, a volatile storage device that stores the data received by the data receiving device, a nonvolatile storage device that retains the storage of the data even after the power is cut, a display control device that causes the nonvolatile display device to display the data stored in the volatile storage device, a storage determining device that determines whether to store the data stored in the volatile storage device into the nonvolatile storage device, and a storage control device that causes the nonvolatile storage device to store the data stored in the volatile storage device when the storage determining device determines to store the data into the nonvolatile storage device.

In addition, in a second aspect of this disclosure, a data transmitting system comprises a display apparatus having a nonvolatile display device that retains display of information even after the power is cut, a data receiving device that receives data to be displayed on the nonvolatile display device, a volatile storage device that stores the data received by the data receiving device, a nonvolatile storage device that retains storage of the data even after the power is cut, a display control device that causes the nonvolatile display device to display the data stored in the volatile storage device, a storage determining device that determines whether to store the data stored in the volatile storage device into the nonvolatile storage device, a storage control device that causes the nonvolatile storage device to store the data stored in the volatile storage device when the storage determining device determines to store the data into the nonvolatile storage device, a storage instruction information receiving device that receives storage instruction information corresponding to the data, and a reception determining device that determines whether the storage instruction information receiving device has received the storage instruction information, wherein, when the reception determining device determines that the storage instruction information has been received, the storage determining device determines whether to store the data stored in the volatile storage device into the nonvolatile storage device, based on the storage instruction information; and a client terminal having a data transmitting device that transmits data to be displayed on the nonvolatile display device of the display apparatus to the display apparatus, an input device that inputs storage instruction information as information related with storage of the data to be transmitted by the data transmitting device into the nonvolatile storage device of the display apparatus, and an input determining device that determines whether the input device has input the storage instruction information, wherein, when the input determining device determines that the storage instruction information has been input, the data transmitting device relates the storage instruction information with the data and transmits the data to the display apparatus.

Other objects, features, and advantages of the present disclosure will be apparent to persons of ordinary skill in the art in view of the following detailed description of embodiments of the disclosure and the accompanying drawings.

### BRIEF DESCRIPTION OF THE DRAWINGS

Exemplary embodiments of the invention will e described below in detail with reference to the accompanying drawings in which:

FIG. 1 is a diagram showing one example of a connecting form of a display apparatus and a client terminal;

FIG. 2 is a block diagram showing electrical configuration of the display apparatus;

FIG. 3 is a schematic diagram showing a configuration of EEPROM of the display apparatus;

FIG. 4 is a block diagram showing electrical configuration of the client terminal;

FIG. 5 is a schematic diagram showing a configuration of HDD of the client terminal;

FIG. 6 is a flowchart showing a main process of the display apparatus;

FIG. 7 is a flowchart showing a subroutine of an image data saving process to be executed in the display apparatus;

FIG. 8 is a flowchart showing a subroutine of an image data transmitting process to be executed in the client terminal;

FIG. 9 is a diagram showing one example of a transmission screen to be displayed on the client terminal;

FIG. 10 is a flowchart showing a main process of the display apparatus according to a first modified embodiment;

FIG. 11 is a flowchart showing a subroutine of the image data saving process of the display apparatus according to the first modified embodiment; and

FIG. 12 is a flowchart showing a subroutine of the image data saving process of the display apparatus according to a second modified embodiment.

### DETAILED DESCRIPTION OF EMBODIMENTS

One embodiment of the present disclosure will be described below with reference to the drawings. The drawings to be referred to are used for describing technical features that can be adopted by the present disclosure, and the present disclosure is not limited to configurations of an apparatuses and flowcharts of various processes shown in the drawings, and these apparatuses and flowcharts are only description examples.

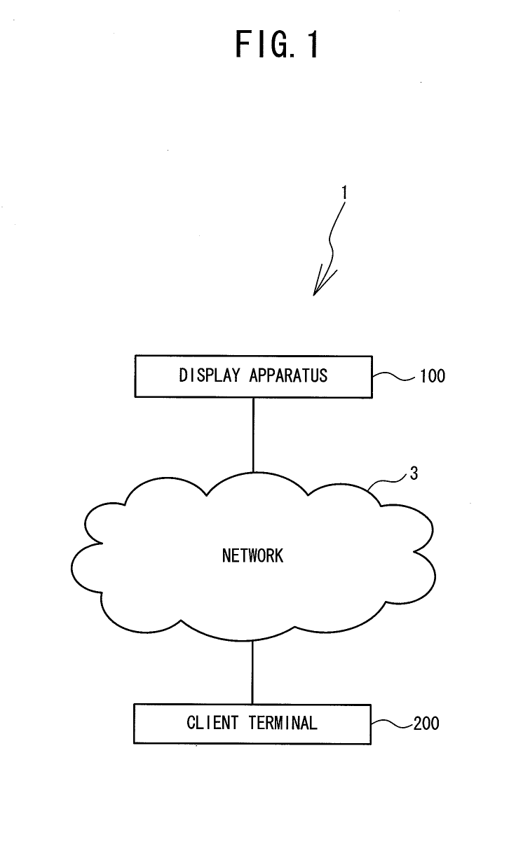

With reference to FIGS. 1 to 5, a description will be given of an entire configuration of a data transmitting system 1 according to the embodiment, and configurations of a display apparatus 100 and a client terminal 200 as components of the data transmitting system 1.

First, an outline of the entire configuration of the data transmitting system 1 will be described with reference to FIG. 1. The data transmission system 1 includes the display apparatus 100 and the client terminal 200. The client terminal 200 is a general-purpose apparatus such as a publicly-known personal computer, and retains and manages data, etc. to be transmitted to the display apparatus 100. The display apparatus 100 is, for example, a portable apparatus such as a mobile phone, an e-book, a PDA or an electrophoretic display device, and has a nonvolatile display portion that retains display of information even when supply of an electric power is cut. The display apparatus 100 and the client terminal 200 can communicate data via a network 3 such as wireless LAN. In this embodiment, the display apparatus 100 receives image data transmitted from the client terminal 200, and displays the data on the nonvolatile display portion. The image data transmitted from the client terminal 200 is such that normal image data is related with enlarged image data and they are transmitted simultaneously. The normal image data is image data having normal size to be displayed on the display apparatus 100, and the enlarged image data is image data that is obtained by enlarging the normal image data. FIG. 1 shows only one display apparatus 100, but actually a plurality of display apparatuses 100 that are owned by individuals in a company may be present.

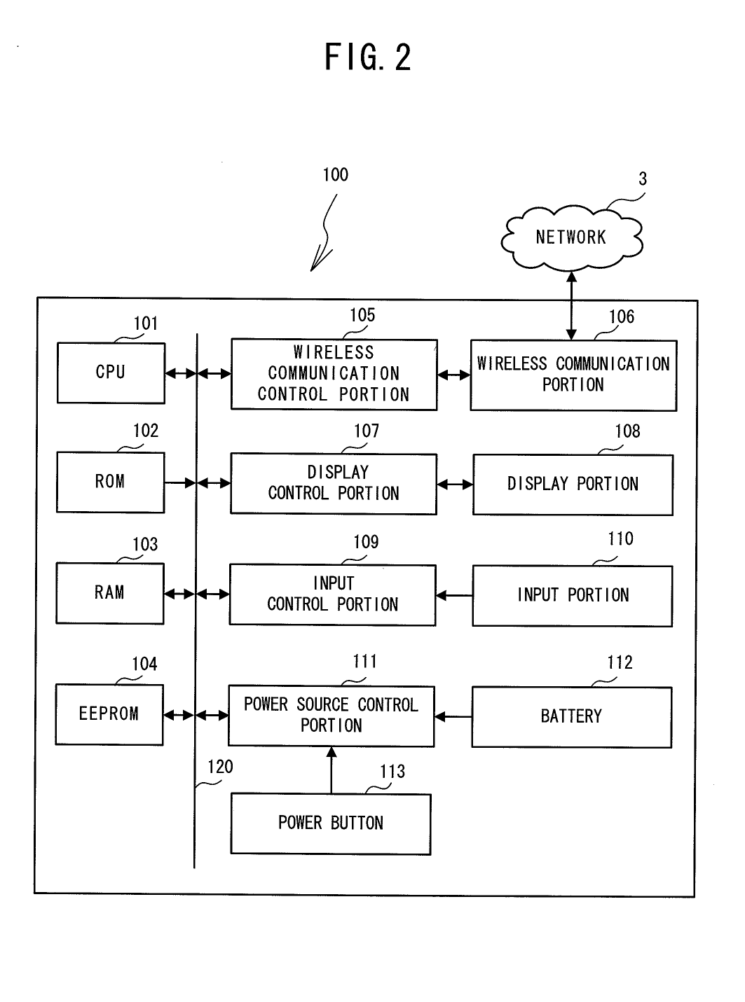

Next, electrical configuration of the display apparatus 100 will be described below with reference to a block diagram of FIG. 2. The display apparatus 100 has a CPU 101 that controls the display apparatus 100. The CPU 101 is connected to a ROM 102, a RAM 103, an EEPROM 104, a wireless communication control portion 105, a display control portion 107, an input control portion 109, and a power source control portion 111 via a bus 120. The wireless communication control portion 105 is connected to an external network 3 via a wireless communication portion 106. The display control portion 107 is connected to a nonvolatile display portion 108. The input control portion 109 is connected to an input portion 110.

The ROM 102 stores a program or the like that actuates the display apparatus 100. The RAM 103 temporarily stores various information. The EEPROM 104 stores image data or the like received from the client terminal 200. The wireless communication control portion 105 controls communication with the client terminal 200 that manages image data to be transmitted to the display apparatus 100. The display control portion 107 controls display of contents data or the like as information such as characters, images, videos or combinations thereof to be displayed on the display portion 108. The input control portion 109 controls input from the input portion 110 composed of a button and a cross key that receive user's inputs. The power source control portion 111 controls a battery 112 that is connected to the display apparatus 100, and a power button 113 switches on and off a power source.

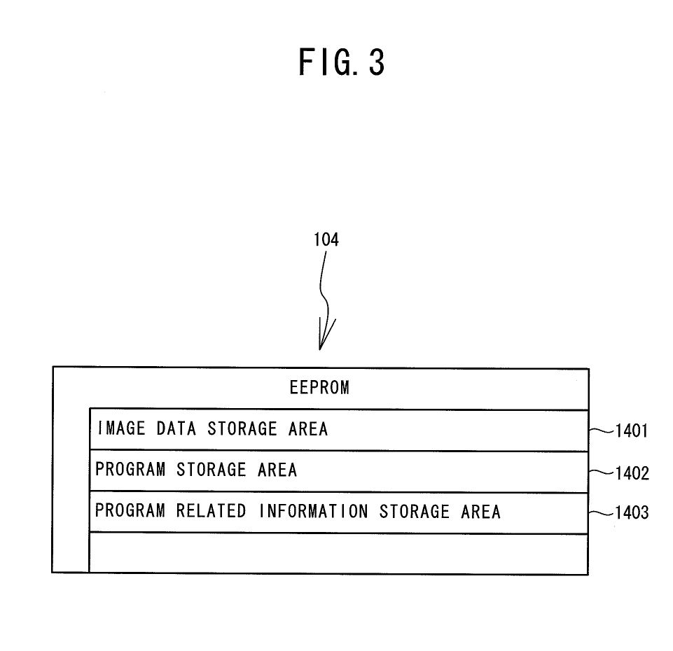

Storage areas of the EEPROM 104 will be described below with reference to FIG. 3. The EEPROM 104 is provided with an image data storage area 1401, a program storage area 1402, and a program related information storage area 1403. Image data received from the client terminal 200 is stored in the image data storage area 1401. Various programs that are executed in the display apparatus 100 are stored in the program storage area 1402. Information such as settings, initial values and data that are necessary for executing the programs is stored in the program related information storage area 1403.

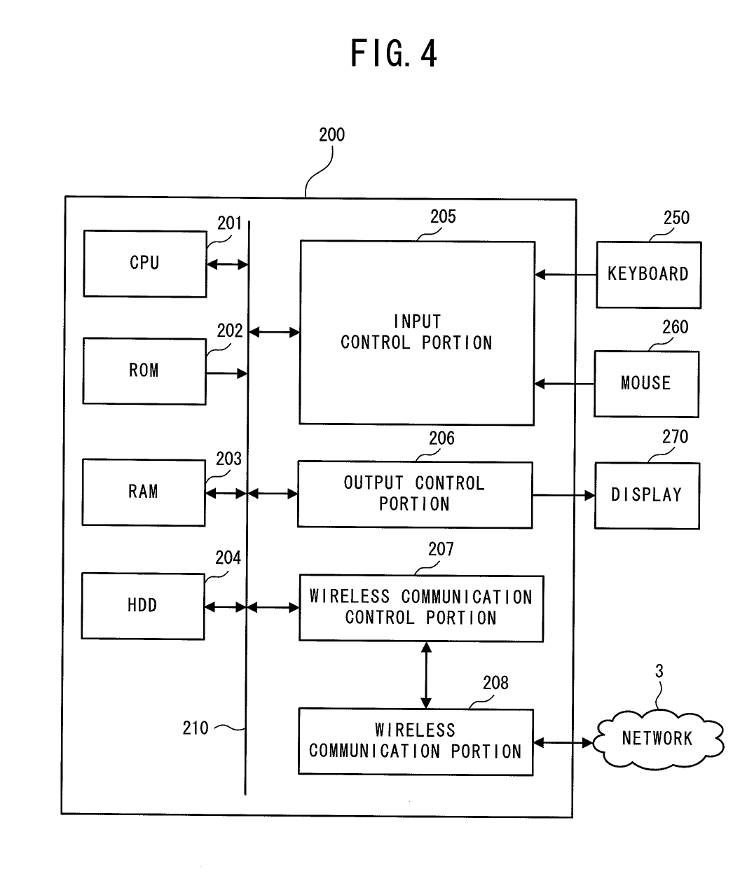

Electrical configuration of the client terminal 200 will be described below with reference to a block diagram of FIG. 4. The client terminal 200 has a CPU 201 that controls the client terminal 200. The CPU 201 is connected to a ROM 202, a RAM 203, a hard disc drive (HDD) 204, an input control portion 205, an output control portion 206, and a wireless communication control portion 207 via a bus 210. The input control portion 205 is connected to a keyboard 250 and a mouse 260. The output control portion 206 is connected to a display 270. The wireless communication control portion 207 is connected to the network 3 via a wireless communication portion 208 that handles wireless communication.

The ROM 202 stores a program or the like of BIOS that actuates the client terminal 200. The RAM 203 temporarily stores various data. The HDD 204 stores, for example, various data including image data to be transmitted to the display apparatus 100, and various programs to be executed in the client terminal 200. The wireless communication control portion 207 makes a control so that image data to be displayed on the display portion 108 of the display apparatus 100 is transmitted to the display apparatus 100 via the wireless communication portion 208 connected to the network 3.

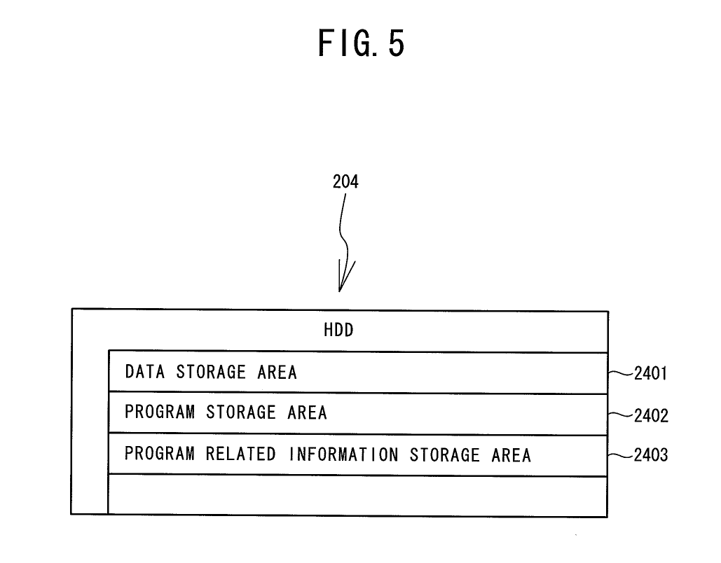

Storage areas of the HDD 204 of the client terminal 200 will be described below with reference to FIG. 5. The HDD 204 is provided with various storage areas such as a data storage area 2401, a program storage area 2402, and a program related information storage area 2403. Image data or the like to be transmitted to the display apparatus 100 is stored in the data storage area 2401. Various programs to be executed in the client terminal 200 are stored in the program storage area 2402. Information such as settings, initial values and data that are necessary for executing the programs is stored in the program related information storage area 2403.

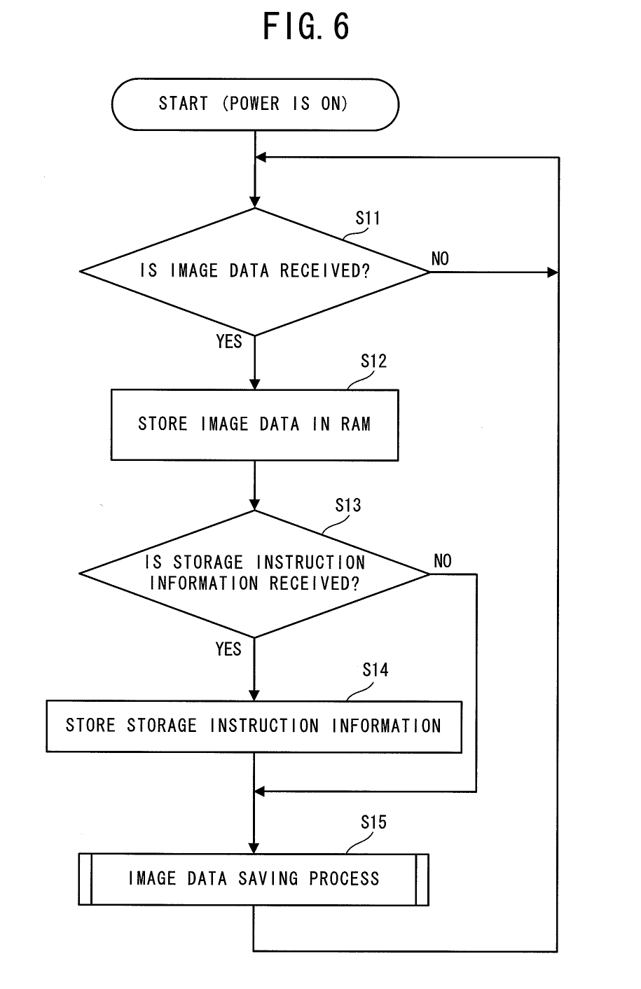

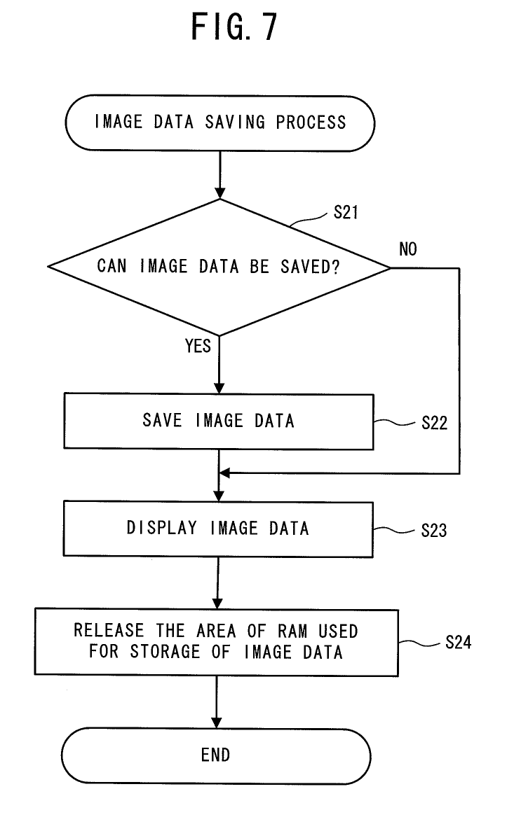

Various processes to be executed in the display apparatus 100 will be described below with reference to FIGS. 6 and 7. A main process of the display apparatus 100 in FIG. 6 is executed when the power of the display apparatus 100 is turned on. The other processes to be executed in the display apparatus 100 are executed in another process. When the power is turned off, the main process is automatically ended.

As shown in FIG. 6, when the main process of the display apparatus 100 is executed, a determination is made whether the display apparatus 100 has received image data to be displayed on the display portion 108 from the client terminal 200 (S11). When the determination is made that the display apparatus 100 has not received image data from the client terminal 200 (NO at S11), the processing goes to S11. This processing is repeated until the display apparatus 100 receives image data from the client terminal 200.

When the determination is made that the display apparatus 100 has received image data from the client terminal 200 (YES at S11), the image data received by the display apparatus 100 is stored in the RAM 103 (S12). At this time, an area in which the received image data can be stored (hereinafter, “image data area”) is secured in the RAM 103, and the image data is stored therein.

Next, a determination is made whether the display apparatus 100 has received storage instruction information from the client terminal 200 (S13). The storage instruction information is related with the image data transmitted from the client terminal 200. The storage instruction information is used for determining whether the image data received by the display apparatus 100 from the client terminal 200 is stored in the image data storage area 1401 of the EEPROM 104. A value “1” representing that the image data is stored in the EEPROM 104, and a value “0” representing that the image data is not stored in the EEPROM 104 are set in the storage instruction information.

When the determination is made that the display apparatus 100 has received the storage instruction information from the client terminal 200 (YES at S13), the received storage instruction information is stored in the RAM 103 (S 14). At this time, an area in which the received storage instruction information can be stored (hereinafter, “storage instruction information area”) is secured in the RAM 103, and the storage instruction information related with the received image data is stored therein. An image data saving process is then executed (S15), and the processing goes to S11. Details of the image data saving process are described later.

When the determination is made that the display apparatus 100 has not received storage instruction information from the client terminal 200 (NO at S13), the processing goes to S15.

The image data saving process will be described below with reference to FIG. 7. This processing is executed in the main process (see FIG. 6) of the display apparatus 100. When the image data saving process is executed, a determination is made whether the image data, that is received from the client terminal 200 and is stored in the image data area of the RAM 103, can be saved in the EEPROM 104 (S21). This determining processing is executed based on the storage instruction information that is related with the image data and is stored in the storage instruction information area of the RAM 103. More specifically, if the value of the storage instruction information is “1”, the determination is made that the image data can be saved in the EEROM 104, and if the value of the storage instruction information is “0”, the determination is made that the image data cannot be saved in the EEPROM 104.

If the determination is made that the image data stored in the image data area of the RAM 103 can be saved in the EEPROM 104 (YES at S21), namely, the value of the storage instruction information that is related with the image data and is stored in the storage instruction information area of the RAM 103 is “1”, the image data is saved in the image data storage area 1401 of the EEPROM 104 (S22). The image data stored in the image data area of the RAM 103 is displayed on the display portion 108 (S23). At this time, normal image data is displayed.

If the determination is made that the image data stored in the image data area of the RAM 103 cannot be saved in the EEPROM 104 (NO at S21), namely, the value of the storage instruction information that is stored in the storage instruction information area of the RAM 103 and is related with the image data is “0”, or no storage instruction information is related with the image data, the processing goes to S23.

Then, the image data area secured in the RAM 103 at S12 of FIG. 6 is released, and the image data stored in the RAM 103 is deleted (S24). If the storage instruction information related with the deleted image data is stored in the storage instruction information area of the RAM 103, the storage instruction information area is simultaneously released, and the storage instruction information stored in the RAM 103 is deleted. The image data saving process is then ended.

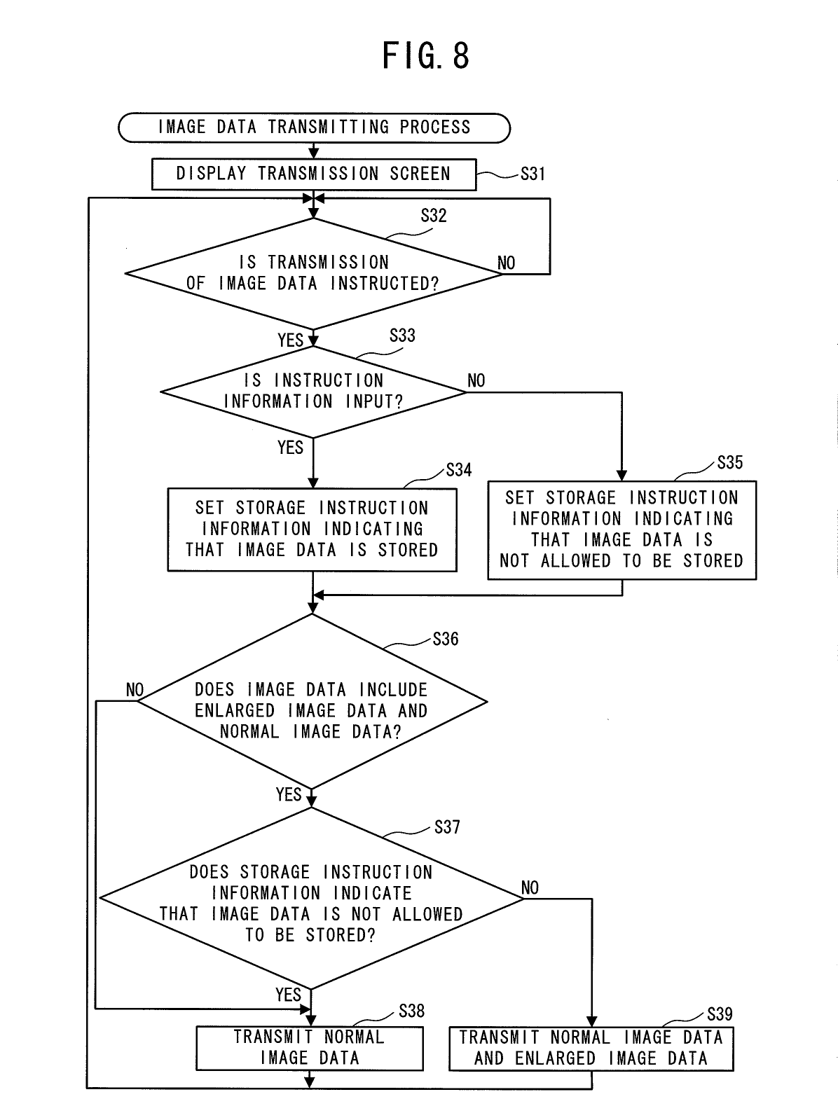

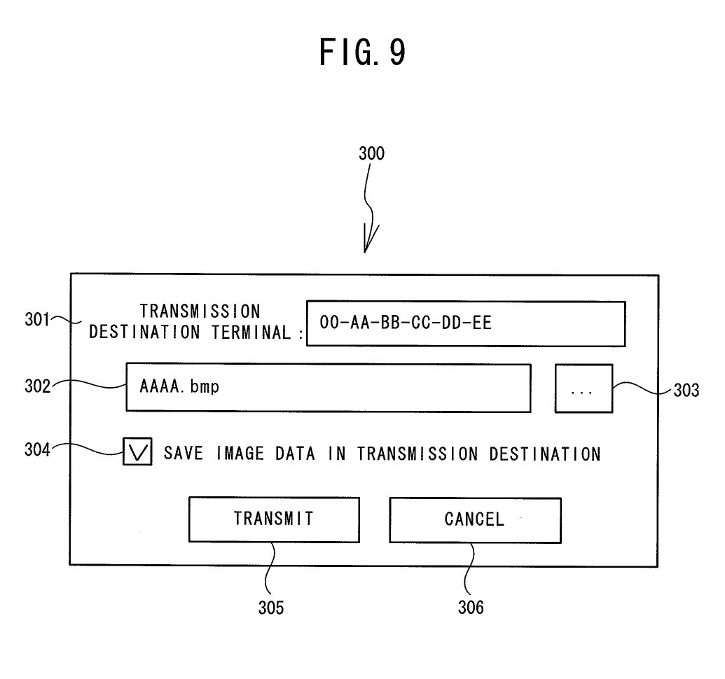

Next, an image data transmitting process to be executed in the client terminal 200 will be described below with reference to FIGS. 8 and 9. The image data transmitting process of FIG. 8 is executed by clicking a transmission screen display button (not shown) for displaying a transmission screen 300 (see FIG. 9). The other processes to be executed in the client terminal 200 are not described.

When the transmission screen display button (not shown) is clicked and the image data transmitting process is executed as shown in FIG. 8, the transmission screen 300 (see FIG. 9) is displayed on a display 270 (S31).

As shown in FIG. 9, the transmission screen 300 is provided with a transmission destination terminal specifying entry 301, a file name specifying entry 302, a file selecting button 303, a data saving check box 304, a transmission button 305, and a cancel button 306.

An address for specifying the display apparatus 100 as a transmission destination of image data is specified on the transmission destination terminal specifying entry 301. In this embodiment, for example, a MAC address for identifying the display apparatus 100 is specified. The address may identify the display apparatus 100 as the transmission destination of image data, and thus an IP address or the like may be specified.

A file name of image data to be transmitted to the display apparatus 100 is specified on the file name specifying entry 302. When the file selecting button 303 is clicked in order to specify a file, a file selector (not shown) is actuated, and the file name of the image data to be transmitted can be selected. FIG. 9 shows that a file whose name is “AAAA.bmp” is selected.

The data saving check box 304 is used for selecting whether image data transmitted to the display apparatus 100 is allowed to be saved in the display apparatus 100 as the transmission destination. FIG. 9 shows that the transmitted image data is allowed to be saved in the display apparatus 100 as the transmission destination.

The transmission button 305 is used for transmitting the image data whose file name is specified on the file name specifying entry 302 to the display apparatus 100 specified on the transmission destination terminal specifying entry 301. The cancel button 306 is used for closing the transmission screen 300.

When the transmission screen 300 shown in FIG. 9 is displayed on the display 270 (S31), a determination is made whether a user of the client terminal 200 has instructed transmission of image data to the display apparatus 100 (S32). That is, the determination is made whether the transmission button 305 on the transmission screen 300 has been clicked. If the determination is made that the user of the client terminal 200 has not instructed the transmission (NO at S32), namely, the user of the client terminal 200 has not clicked the transmission button 305, the processing goes to S32. This processing is repeated until the transmission button 305 is clicked. When the cancel button 306 is clicked in a state that the transmission screen 300 is displayed, the image data transmitting process is ended.

If the determination is made that the user of the client terminal 200 has instructed the transmission of the image data (YES at S32), namely, the transmission button 305 has been clicked, a determination is made whether instruction information has been input (S33). The instruction information relates to availability in the display apparatus 100 of saving of image data to be transmitted to the display apparatus 100 as the transmission destination. The determination whether the instruction information has been input is made by a determination whether the data saving check box 304 on the transmission screen 300 has been checked.

If the determination is made that the instruction information has been input (YES at S33), storage instruction information indicating the storage of the image data into the display apparatus 100 is related with the image data to be transmitted (S34). That is, the value “1” as the storage instruction information is related with the image data to be transmitted.

Then, a determination is made whether the image data includes normal image data of normal size to be displayed on the display portion 108 and enlarged image data of enlarged size (S36).

If the determination is made that instruction information has not been input (NO at S33), storage instruction information indicates that the image data is not allowed to be stored into the display apparatus 100 is related with the image data to be transmitted (S35). That is, the value “0” as the storage instruction information is related with the image data to be transmitted. The processing goes to S36.

If the determination is made that the image data includes normal image data and enlarged image data (YES at S36), then a determination is made whether the storage instruction information indicates that the image data is not allowed to be stored into the display apparatus 100 (S37). That is, the determination is made whether the value of the storage instruction information related with the image data is “0”.

If the determination is made that the storage instruction information indicates that the image data is not allowed to be stored into the display apparatus 100 (YES at S37), namely, the value of the storage instruction information related with the image data is “0”, only the normal image data is transmitted to the display apparatus 100 (S38). The processing then goes to S32. The normal image data to be transmitted is normal image data of image data specified on the file name specifying entry 302 of the transmission screen 300. The transmission destination of the normal image data is the display apparatus 100 specified on the transmission destination terminal specifying entry 301 of the transmission screen 300.

The determination is made that the storage instruction information indicates that the image data is stored into the display apparatus 100 (NO at S37), namely, the value of the storage instruction information related with the image data is “1”, the normal image data and the enlarged image data are transmitted to the display apparatus 100 (S39). The processing then goes to S32. The normal image data and enlarged image data to be transmitted are the normal image data and enlarged image data of the image data specified on the file name specifying entry 302 on the transmission screen 300. The transmission destination of the normal image data and the enlarged image data is the display apparatus 100 specified on the transmission destination terminal specifying entry 301 on the transmission screen 300.

If the determination is made that the image data does not include normal image data and enlarged image data (NO at S36), namely, enlarged image data is not present but only normal image data is present, the processing goes to S38.

As described above, in this embodiment, when the client terminal 200 transmits image data to the display apparatus 100, the determination is made whether the image data is stored in the image data storage area 1401 of the EEPROM 104 as a nonvolatile storage medium provided to the display apparatus 100. The client terminal 200 relates storage instruction information according to the determination with the image data to be transmitted and transmits it to the display apparatus 100. The display apparatus 100 displays the image data received from the client terminal 200 to the nonvolatile display portion 108. The determination is made whether the image data is stored in the image data storage area 1401 of the EEPROM 104, based on the storage instruction information related with the received image data. If the determination is made that the received image data is stored, the image data is stored in the image data storage area 1401 of the EEPROM 104.

As a result, the user of the client terminal 200 determines whether the image data to be transmitted to the display apparatus 100 is stored in the EEPROM 104 of the display apparatus 100, and can transmit the image data to the display apparatus 100. The display apparatus 100 displays the received image data on the nonvolatile display portion 108. The determination can be made whether the image data is stored in the EEPROM 104, based on the contents of the storage instruction information related with the received image data. As a result, a user of the display apparatus 100 can only confirm the image data that is not desired to be stored into the nonvolatile EEPROM 104 on the display portion 108. The user of the display apparatus 100 can be prevented from reusing the received image data.

The present disclosure is not limited to the above embodiment, and various modifications may occur within the scope of the present disclosure. Modified examples will be described below.

In the above embodiment, the determination is made whether image data transmitted from the client terminal 200 is stored in the image data storage area 1401 of the EEPROM 104 of the display apparatus 100, based only on the storage instruction information related with the transmitted image data. However, the present disclosure is not limited to this.

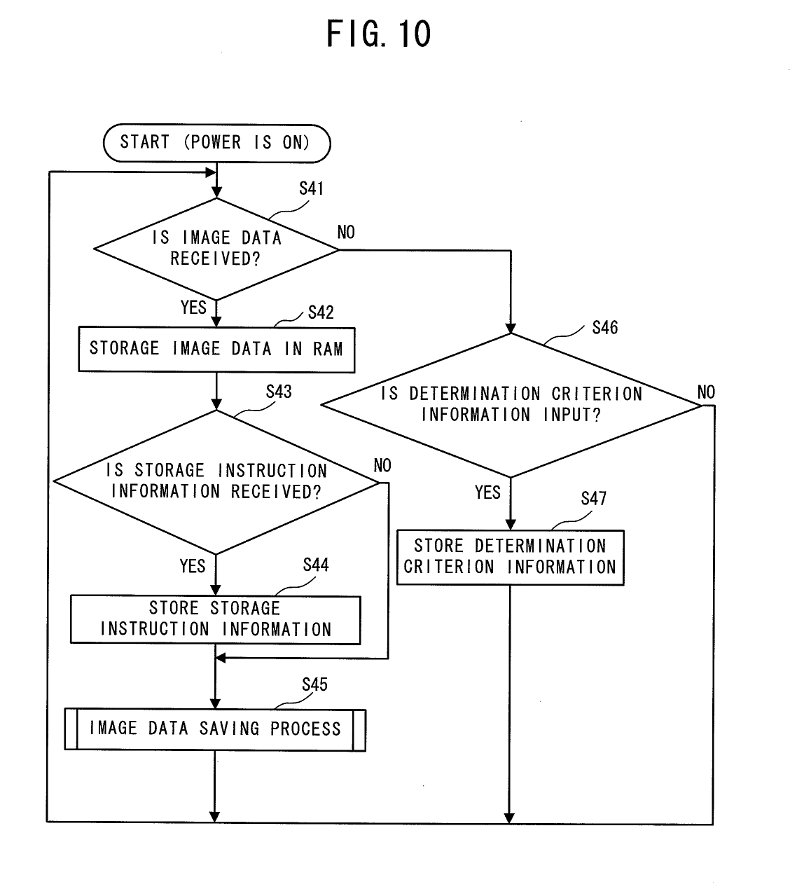

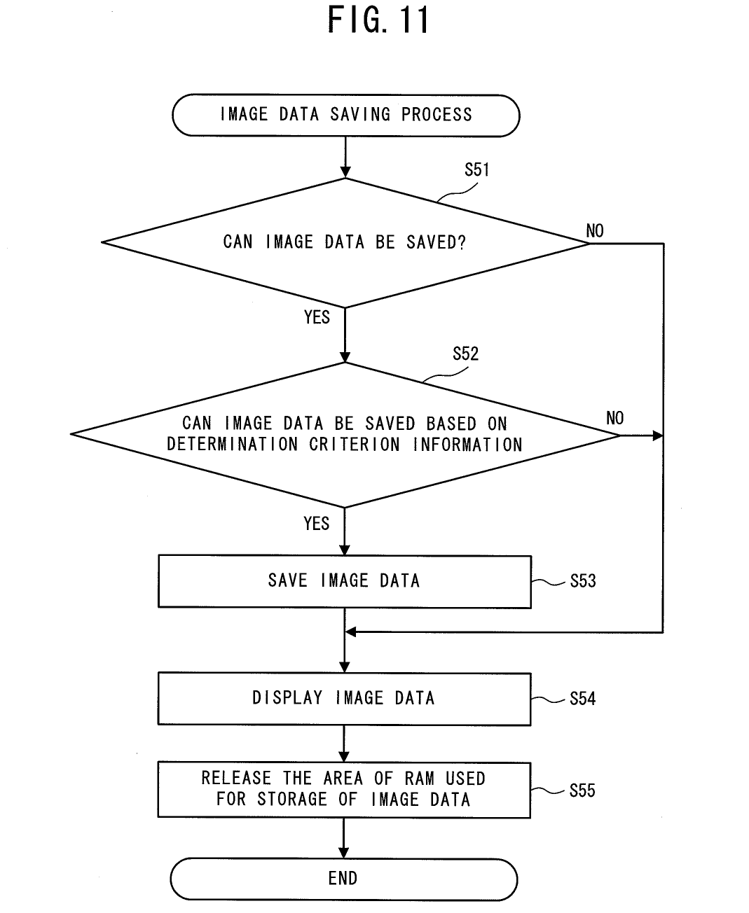

For example, a determination criterion for determining the storage is set in the display apparatus 100 in advance, and the determination may be made whether the image data received from the client terminal 200 is stored in the EEPROM 104, based on the determination criterion. Further, the determination criterion and the storage instruction information may be used together. This will be described with reference to FIGS. 10 and 11. A main process of the display apparatus 100 according to a first modified embodiment in FIG. 10 is executed when the power of the display apparatus 100 is turned on, similarly to the above embodiment. The other processes to be executed in the display apparatus 100 are executed in another processing. When the power is turned off, the main process is automatically ended. Since steps S41 to S45 of the main process in FIG. 10 are similar to steps S11 to S15 of the main process (see FIG. 6) in the above embodiment, the description thereof is omitted.

As shown in FIG. 10, when the main process according to the first modified embodiment is executed, a determination is made whether image data to be displayed on the display portion 108 of the display apparatus 100 has been received from the client terminal 200 (S41). If the determination is made that image data has not been received from the client terminal 200 (NO at S41), a determination is made whether determination criterion information has been input from the user (S46). The determination criterion information is used for determining whether image data received from the client terminal 200 is stored in the image data storage area 1401 of the EEPROM 104 of the display apparatus 100. In the first modified embodiment, the determination criterion information is input, for example, according to a change state of a determination criterion information input button (not shown) provided to the input portion 110 of the display apparatus 100. A toggle switch is used here as the determination criterion information input button, and every time the toggle switch is pushed, determination criterion information is input. When the toggle switch is ON, image data is saved, and when the toggle switch is OFF, image data is not saved. In the first modified embodiment, the determination criterion information is input simply according to the state change of the determination criterion input button, but another method for inputting determination criterion may be used. For example, determination criterion information that gives a limitation according to a capacity of received image data, or a part of a file name and a file type such as “image data whose file name includes “*.bmp” is saved” may be input as a condition. Further, two or more pieces of determination criterion information may be combined.

When the determination is made that determination criterion information has not been input (NO at S46), the processing goes to S41. Steps (NO at S41 and NO at S46) are repeated until image data is received from the client terminal 200 or determination criterion information is input.

When determination criterion information is input (YES at S46), the input determination criterion information is stored in a determination criterion information storage area (not show) of the EEPROM 104 (S47). Then, the processing goes to S41.

Next, the image data saving process according to the first modified embodiment will be described below with reference to FIG. 11. When the image data saving process is executed, a determination is made whether the image data that is transmitted from the client terminal 200 and is stored in the image data area of the RAM 103 can be saved in the EEPROM 104 (S51). This determining processing is executed based on storage instruction information that is related with the image data and is stored in the storage instruction information area of the RAM 103. That is, if the value of the storage instruction information is “1”, the determination is made that the image data can be saved in the EEPROM 104, and if the value of the storage instruction information is “0”, the determination is made that the image data cannot be saved in the EEPROM 104.

If the determination is made that the image data stored in the image data area of the RAM 103 can be saved in the EEPROM 104 (YES at S51), namely, the value of the storage instruction information related with the image data and stored in the storage instruction information area of the RAM 103 is “1”, a determination is made whether the image data stored in the image data area of the RAM 103 can be saved in the EEPROM 104 based on determination criterion information (S52). The determination criterion information is information stored in the determination criterion information storage area (not shown) of the EEPROM 104 at S47 in FIG. 10. In an initial state that the processing at S47 in FIG. 10 is never executed, the determination criterion information input button is in the OFF state.

If the determination is made that the image data stored in the image data area of the RAM 103 can be saved in the EEPROM 104, based on the determination criterion information (YES at S52), namely, the determination criterion information input button is ON, the received image data is saved in the image data storage area 1401 of the EEPROM 104 (S53). Then, the image data stored in the image data area of the RAM 103 is displayed on the display portion 108 (S54). At this time, normal image data is displayed.

If the determination is made that the image data stored in the image data area of the RAM 103 cannot be saved in the EEPROM 104 (NO at S51), namely, the value of the storage instruction information related with the image data stored in the image data area of the RAM 103 and stored in the storage instruction information area of the RAM 103 is “0”, or no storage instruction information is related, the processing goes to S54.

If the determination is made that the image data stored in the image data area of the RAM 103 cannot be saved in the EEPROM 104, based on the determination criterion information (NO at S52), namely, the determination criterion information input button is OFF and the condition of the determination criterion information is not satisfied, the processing goes to S54.

When the image data stored in the image data area of the RAM 103 is displayed on the display portion 108 at S54, the image data area secured in the RAM 103 is released at S12 in FIG. 6, and the image data stored in the RAM 103 is deleted (S55). The storage instruction information that is related with the image data and is stored in the storage instruction information area of the RAM 103 is simultaneously deleted when the storage instruction information area is released. The image data saving process is then ended.

In the first modified embodiment, determination criterion information as information for determining whether received image data is stored in the nonvolatile EEPROM 104 can be set. The image data stored in the image data area of the RAM 103 is stored only when the determination is made that the image data is stored in the nonvolatile EEPROM 104, based on the storage instruction information and the determination criterion information. As a result, since the determination is made whether the image data is stored based on the preset determination criterion information, the user of the display apparatus 100 does not have to store unnecessary image data. As a result, a used amount of the EEPROM 104 can be reduced.

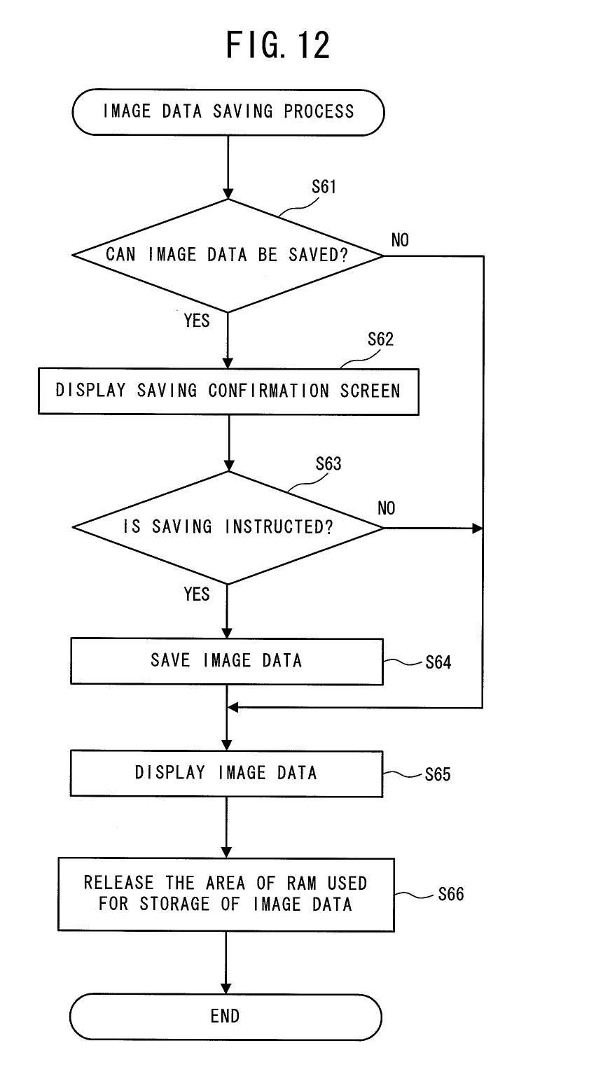

For example, every time image data is received from the client terminal 200, the user of the display apparatus 100 may be instructed to determine whether the image data is saved in the image data storage area 1401 of the EEPROM 104. Further, the determination criterion and the storage instruction information may be used together. This will be described with reference to FIG. 12. Since the other processes to be executed in the display apparatus 100 are similar to those in the embodiment, the description thereof is omitted. The image data saving process according to a second modified embodiment is executed in the main process (see FIG. 6) of the display apparatus 100 similarly to the embodiment.

When the image data saving process according to the second modified embodiment in FIG. 12 is executed, a determination is made whether image data that is transmitted from the client terminal 200 and is stored in the image data area of the RAM 103 can be saved in the EEPROM 104 (S61). The determination is made based on storage instruction information that is related with the image data and is stored in the storage instruction information area of the RAM 103. That is, if the value of the storage instruction information is “1”, the determination is made that the image data can be saved in the EEPROM 104. If the value of the storage instruction information is “0”, the determination is made that the image data cannot be saved in the EEPROM 104.

If the determination is made that the image data stored in the image data area of the RAM 103 can be saved in the EEPROM 104 (YES at S61), namely, the value of the storage instruction information related with the image data and stored in the storage instruction information area of the RAM 103 is “1”, a saving confirmation screen (not shown) is displayed on the display portion 108 (S62). The saving confirmation screen shows a message such as “Is the received image data saved?”.

A determination is made whether the user of the display apparatus 100 has instructed the saving of the received image data into the EEPROM 104 (S63). That is, the determination is made whether an approval button (not shown) provided to the input portion 110 has been clicked. If the user of the display apparatus 100 instructs the saving (YES at S63), namely, the approval button is clicked, the image data stored in the image data area of the RAM 103 is saved in the image data storage area 1401 of the EEPROM 104 (S64). The image data stored in the image data area of the RAM 103 is displayed on the display portion 108 (S65). At this time, normal image data is displayed.

If the determination is made that the image data stored in the image data area of the RAM 103 cannot be saved in the EEPROM 104 (NO at S61), namely, the value of the storage instruction information related with the image data and stored in the storage instruction information area of the RAM 103 is “0”, or storage instruction information is not related with the image data, the processing goes to S65.

If the user does not instruct the saving of the received image data into the EEPROM 104 (NO at S63), namely, the cancel button (not shown) provided to the input portion 110 is clicked, the processing goes to S65.

The image data area secured in the RAM 103 at S12 in FIG. 6 is released, and the image data stored in the RAM 103 is deleted (S66). If storage instruction information is related with the image data and is stored in the storage instruction information area of the RAM 103, the storage instruction information area is also released, and the storage instruction information stored in the RAM 103 is simultaneously deleted. The image data saving process is then ended.

In the second modified embodiment, if the determination is made that the received image data is stored in the EEPROM 104, based on the storage instruction information, the saving confirmation screen is displayed on the display apparatus 100. When the user clicks the approval button of the input portion 110, the received image data is stored in the EEPROM 104. As a result, the user of the display apparatus 100 can instruct whether the image data determined to be stored into the EEPROM 104 based on the storage instruction information is stored. As a result, unnecessary image data is prevented from being stored in the EEPROM 104 of the display apparatus 100, and the used amount of the EEPROM 104 can be reduced.

While the invention has been described in connection with various exemplary structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A display apparatus, comprising:
a nonvolatile display device that retains display of information even after the power is cut;
a data receiving device that receives data to be displayed on the nonvolatile display device;
a volatile storage device that stores the data received by the data receiving device;
a nonvolatile storage device that retains the storage of the data even after the power is cut;
a display control device that causes the nonvolatile display device to display the data stored in the volatile storage device;
a storage determining device that determines whether to store the data stored in the volatile storage device into the nonvolatile storage device; and
a storage control device that causes the nonvolatile storage device to store the data stored in the volatile storage device when the storage determining device determines to store the data into the nonvolatile storage device.

2. The display apparatus according to claim 1, further comprising:
a storage instruction information receiving device that receives storage instruction information corresponding to the data; and
a reception determining device that determines whether the storage instruction information receiving device has received the storage instruction information,
wherein, when the reception determining device determines that the storage instruction information has been received, the storage determining device determines whether to store the data stored in the volatile storage device into the nonvolatile storage device, based on the storage instruction information.

3. The display apparatus according to claim 1, further comprising:
a determination criterion setting device that sets a determination criterion as a predetermined criterion for determining whether the data is stored in the nonvolatile storage device,
wherein the storage determining device determines whether to store the data into the nonvolatile storage device, based on the determination criterion set by the determination criterion setting device.

4. The display apparatus according to claim 1, further comprising:
an instructing device that gives an instruction to cause the nonvolatile storage device to store the data received by the data receiving device;
an notification device that makes a notification as to input of an instruction through the instructing device; and
an instruction determining device that determines whether the instructing device gives the instruction after the notification device makes a notification,
wherein, when the instruction determining device determines that the instructing device has instructed the nonvolatile storage device to store the data, the storage control device causes the nonvolatile storage device to store the data stored in the volatile storage device.

5. A data transmitting system, comprising:
a display apparatus comprising:
a nonvolatile display device that retains display of information even after the power is cut;
a data receiving device that receives data to be displayed on the nonvolatile display device;
a volatile data storage device that stores the data received by the data receiving device;
a nonvolatile storage device that retains storage of the data even after the power is cut;
a display control device that causes the nonvolatile display device to display the data stored in the volatile storage device;
a storage determining device that determines whether to store the data stored in the volatile storage device into the nonvolatile storage device;
a storage control device that causes the nonvolatile storage device to store the data stored in the volatile storage device when the storage determining device determines to store the data into the nonvolatile storage device;
a storage instruction information receiving device that receives storage instruction information corresponding to the data; and
a reception determining device that determines whether the storage instruction information receiving device has received the storage instruction information, wherein, when the reception determining device determines that the storage instruction information has been received, the storage determining device determines whether to store the data stored in the volatile storage device into the nonvolatile storage device, based on the storage instruction information; and
a client terminal comprising:
a data transmitting device that transmits data to be displayed on the nonvolatile display device of the display apparatus to the display apparatus;
an input device that inputs storage instruction information as information related with storage of the data to be transmitted by the data transmitting device into the nonvolatile storage device of the display apparatus; and
an input determining device that determines whether the input device has input the storage instruction information,
wherein, when the input determining device determines that the storage instruction information has been input, the data transmitting device relates the storage instruction information with the data and transmits the data to the display apparatus.

6. The data transmitting system according to claim 5,
the client terminal further comprising:
an image data determining device that determines whether the data to be transmitted by the data transmitting device includes first image data and second image data that is image data obtained by enlarging the first image data; and
a storage instruction information determining device that determines whether the storage instruction information input by the input device indicates that the data is not allowed to be stored into the nonvolatile storage device,
wherein, when the image data determining device determines that the data includes the first image data and the second image data, and when the storage instruction information determining device determines that the storage instruction information indicates that the data is not allowed to be stored into the nonvolatile storage device, the data transmitting device transmits only the first image data instead of the data.
